(19) United States
(12) Patent Application Publication
(10) Pub. No.: US 2026/0206815 A1
(43) Pub. Date: Jul. 23, 2026

(54) Pet Food Flavor Enhancement Processing System

(71) Applicant: TAN GROW INC., BLUE ISLAND, IL (US)

(72) Inventor: Mengmeng MU, Ningbo (CN)

(21) Appl. No.: 19/292,940

(22) Filed: Aug. 7, 2025

Related U.S. Application Data
(63) Continuation-in-part of application No. 19/280,119, filed on Jul. 25, 2025.
Application No. 19/280,119 is a continuation of application No. PCT/CN2025/073913, filed on Jan. 22, 2025.

(30) Foreign Application Priority Data
Jul. 29, 2025 (CN) 2025110638801

(51) Int. Cl. A23N 17/00; A23K 40/30

(52) U.S. Cl. CPC A23N 17/004; A23K 40/30; A23N 17/007

(57) ABSTRACT

A pet food flavor enhancement processing system includes an automatic slurry coating assembly which includes a rotation motor and a pot for receiving a slurry material and a pet food raw material, the pot is driven by the rotation motor to allow the slurry material to be coated on the surface of the pet food raw material.A eating assembly is provided to dry the slurry material to promote solidification of the slurry material for forming a flavor enhancement layer on the pet food raw material.

### CROSS REFERENCE OF RELATED APPLICATION

This application is a Continuation-In-Part application that claims the benefit of priority under 35U.S.C.§120 to a non-provisional application, application number 19/280, 119, filed on 07/25/2025, which is a Continuation Application of PCT/CN2025/073913, filed January 22, 2025, which claims priority under 35 U.S.C. 119(a-d) to Chinese application numbers 202410095353.8, filed January 23, 2024; this application also is a non-provisional application that claims priority under 35U.S.C. §119 to China application number CN202511063880.1, filing date 05/29/2025, wherein the entire content of which is expressly incorporated herein by reference.

### BACKGROUND OF THE PRESENT INVENTION

### Field of Invention

The present invention relates to field of pet food processing, and more particular to a pet food flavor enhancement processing system.

### Description of Related Arts

In recent years, more and more people have been keeping pets, and the increase in people's disposable income has helped them increase their spending on pet food, pet supplies, and pet services. The trend of pet-friendly pets will further encourage owners to buy better products for their pets, such as the most basic staple food, pet snacks, and pet health products.

With the development of the pet economy, pet owners and pets have higher and higher requirements for the quality and taste of pet food. Pet owners pay more attention to the nutrition and taste of pet food, and the taste of pet food directly affects the appetite and health of pets. When processing traditional pet food, some rely on the flavor of the raw materials themselves or add flavor powder to season. Some are pressed and molded by mixing multiple raw materials, but these pet foods often have a single taste in taste and cannot meet the needs of some pets, especially picky pets. If the pet food bought back is not liked by the pet, it will cause waste. And the owner is not interactive during the feeding process with the pet. Therefore, it is particularly important to develop a flavoring processing method that can improve the taste of pet food and increase the fun of the owner feeding the pet.

### SUMMARY OF THE PRESENT INVENTION

An advantage of the present invention is that it provides a pet food flavoring processing method which can significantly improve the taste and flavor of pet food, better meet the taste needs of pets, and involve the owner in the process of preparing pet food, thereby increasing the fun of pet raising.

Another advantage of the present invention is that it provides a method for processing pet food flavor enhancement, which can stimulate the pet's sense of smell and taste by attaching a flavor enhancement layer on the surface of the pet food, making the pet food more attractive, thereby increasing the pet's appetite, especially having a positive effect on those pets who are picky eaters or have poor appetite.

Another advantage of the present invention is that it provides a pet food flavoring processing method which can increase the nutritional content of the pet food by adding a flavor enhancement layer outside the pet food.

Another advantage of the present invention is that it provides a pet food flavoring processing method, wherein in the pet food product produced by the pet food flavoring processing method, the flavor enhancement layer can be designed with a variety of flavors according to the taste preferences of different pets, such as meat flavor, fish flavor, vegetable flavor, etc., to meet the personalized needs of different pets.

Another advantage of the present invention is that it provides a pet food flavoring processing method, wherein in the pet food product produced by the pet food flavoring processing method, the addition of the flavor enhancement layer not only increases the flavor, but also improves the taste of the pet food, making it crispy or soft and tender, and can be adjusted according to the preferences of different pets.

Another advantage of the present invention is that it provides a pet food flavoring processing method, wherein the pet owner adjusts the ingredients of the flavor enhancement layer based on the pet's feedback, thereby finding the taste that his or her pet likes, increasing the pet owner's satisfaction, cultivating the pet owner's sense of responsibility and love, and enhancing the relationship between the pet and the owner.

Another advantage of the present invention is that it provides a pet food flavoring processing method, and a processing equipment provided is suitable for use at home or in a pet management center.

According to an aspect of the present invention, the present invention provides a pet food flavoring processing method which comprises the following step:

(a) applying a flavoring material which is in contact with a surface of a pet food raw material to form a flavor enhancement layer on the surface of the pet food raw material.

According to one embodiment, before the step (a), the flavoring material is manufactured from a flavoring raw material, and the flavoring material is liquid, slurry, solid or gas.

According to one embodiment, in the step (a), the flavoring raw material is selected from meat, vegetable, fruit or dairy product.

According to one embodiment, in the step (a), the flavoring raw material is formed by pulping with water, squeezing with water, or cutting and grinding.

According to one embodiment, in the step (a), the surface of the pet food raw material is coated to form the flavor enhancement layer by at least one of spraying, soaking, brushing, vibration and liquid stirring.

According to one embodiment, the method further comprises a step of:

solidifying the flavor enhancement layer on the surface of the pet food raw material.

According to one embodiment, the flavor enhancing layer is matured and fixed on the surface of the pet food raw material by drying.

According to one embodiment, the flavor enhancement layer has a thickness of 0.1 to 5.0 mm.

According to one embodiment, the surface of the pet food raw material is evenly coated with the flavor enhancing layer.

According to one embodiment, the steps of preparing the flavoring material, coating the flavor enhancement layer, and solidifying the flavor enhancement layer are automatically completed in a pet food flavoring processing device.

The present invention further provides a pet food flavor enhancement processing system comprising an automatic slurry coating assembly for coating a slurry material on a surface of a pet food raw material to form a flavor enhancement layer on the surface of the pet food raw material.

According to one embodiment, the automatic slurry coating assembly is configured to coat the slurry material on the surface of the pet food raw material by one of spraying, soaking, brushing, vibration and liquid stirring.

According to one embodiment, the automatic slurry coating assembly comprises a rotation motor and a pot for receiving the slurry material and the pet food raw material, wherein the pot is driven by the rotation motor to allow the slurry material to be coated on the surface of the pet food raw material.

According to one embodiment, the automatic slurry coating assembly further comprises a rotation pot base coupled to the rotation motor, wherein the pot is detachably coupled on the rotation pot base.

According to one embodiment, the rotation pot base comprises a rotation container having a receiving chamber and an opening communicated to the receiving chamber, the pot is detachably disposed into the receiving chamber of the rotation pot base through the opening.

According to one embodiment, the pot comprises a bottom wall and a surrounding wall connected to the bottom wall to define an inner chamber having an access opening, wherein the rotation container comprises a bottom surface and a surrounding surface connected to the bottom surface to define the receiving chamber, wherein the surrounding surface of the rotation container is matched with and in frictional contact with the surrounding wall of the pot, so as to allow the rotation container to drive the pot to rotate, wherein the rotation motor is mounted at a bottom of the rotation container.

According to one embodiment, a heating assembly is provided to dry the slurry material to promote solidification of the slurry material for forming the flavor enhancement layer on the pet food raw material.

According to one embodiment, the heating assembly comprises a heating element for heating the pot.

According to one embodiment, an air blower assembly which comprises a blower housing and an air blower disposed in the blower housing for generating an air flow is provided, wherein the heating assembly comprises a heating element which is disposed in the blower housing for heating the air flow from the air blower, and a heat air duct for guiding heated air to the pot.

According to one embodiment, a housing having a cavity for receiving the pot, is provided, wherein the housing has air outlet formed in the housing and is communicated to the cavity and the heat air duct, wherein the air outlet is above the pot and is oriented to direct heated air into the pot.

According to one embodiment, the system comprises a slurry supply assembly which comprises a pulping unit for preparing the slurry material based on a raw material which is added with water, and a slurry feeding unit for feeding the slurry material to the pot.

According to one embodiment, the pulping unit comprises a pulping container for receiving the raw material of the slurry material, a mincing element for mincing the raw material of the slurry material, a pulping driving mechanism for driving movement of the mincing element, a water feeding unit for feeding water into the pulping container.

According to one embodiment, the pulping driving mechanism comprises a shell, a driving motor, and a crank-slider linkage mechanism mounted to the shell, wherein the mincing element is detachably mounted to the shell, the driving motor is configured to drive the mincing element to perform a reciprocating up-and-down motion via the crank-slider linkage mechanism.

According to one embodiment, the pulping unit comprises further comprises a container base for receiving the pulping container, wherein the pulping container is provided with a slurry supply duct which comprises an outlet tube, the slurry feeding unit comprises a pump, a feeding pipe and a connector, wherein the feeding pipe is connected to the pump and the connector, the connector is connected to the outlet tube when the pulping container is detachably mounted on the container base.

According to one embodiment, the water feeding unit comprises a water tank and a water inlet slider element which is connected to the water tank, wherein the pulping container has a groove, the water inlet slider element is pushed downward and locked into the groove of the pulping container when the pulping container is detachably mounted on the container base, wherein the water feeding unit further comprises a return spring to cause the water inlet slider element to automatically move upward for disengaging from the groove of the pulping container when the pulping container is removed from the container base.

According to one embodiment, the slurry supply assembly further comprises a weighting unit which is used to weigh a weight of the raw material of the slurry material added into the pulping container, so as to determine an amount of the water added into the pulping container for preparing the slurry material.

According to one embodiment, the slurry feeding unit comprises comprises a pump, a feeding pipe connected to the pump and communicated to the pulping container for feeding the slurry material to the pot, and an air flow duct, wherein the feeding pipe comprises a nozzle outlet, wherein a stream of pressurized airflow is introduced to the nozzle outlet to atomize and diffuse the slurry material by the air flow duct.

According to one embodiment, a pet food feeding mechanism is provided for automatically feeding a plurality of the pet food raw materials into the pot, wherein the pet food feeding mechanism comprises a pet food storing container for storing the plurality of pet food raw materials, and a pet food feeding unit for feeding the plurality of pet food raw materials from the pet food storing container to the pot.

According to one embodiment, the pet food feeding unit comprises a feeding driving motor, a transmission shaft coupled to the feeding driving motor, and a rotation disc inclinedly arranged in the pet food storing container and coupled to the transmission shaft, wherein the pet food storing container has an pet food outlet positioned above the pot, the rotation disc has at least one discharge outlet , wherein when the feeding driving motor is in operation to drive the transmission shaft to rotate, the rotation disc is driven to rotate by the transmission shaft, when the discharge outlet is aligned with the pet food outlet, the pet food raw materials in the pet food storing container drops into the pot because of gravity through the discharge outlet and the pet food outlet.

According to one embodiment, the pet food feeding unit further comprises an infrared transmitting source, an infrared receiver, and an infrared-permeable area on the pet food storing container, wherein the infrared transmitting source and the infrared receiver are arranged on two opposite sides of the infrared-permeable area, wherein when an amount of the pet food raw materials in the pet food storing container is insufficient, an infrared signal emitted by the infrared transmitting source passes through the infrared-permeable area and reaches the infrared receiver.

According to one embodiment, the system further comprises a cleaning assembly which comprises a water heater connected to the water tank, a water pump connected to the water heater, and a water feeding pipe connected to the water pump for feeding heated water into the pot.

According to one embodiment, the cleaning assembly further comprises a drain motor, a wastewater suction pipe and a wastewater peristaltic pump, wherein the the drain motor is configured to drive the wastewater suction pipe to rotate downward to allow a lower end thereof to extend into the pot, the wastewater peristaltic pump extracts wastewater from the pot through the wastewater suction pipe.

According to one embodiment, the pet food raw material is a commercial sold product.

According to one embodiment, the raw material of the slurry material is selected from the group consisting of meat, vegetable, fruit and dairy product.

Further objects and advantages of the present invention will be fully apparent from an understanding of the following description and the accompanying drawings.

### BRIEF DESCRIPTION OF THE DRAWINGS

FIG. 1 is a cross-sectional view of a pet food raw material in a pet food flavoring processing method according to a preferred embodiment of the present invention.

FIG. 2 is a cross-sectional view of a pet food processed food according to the pet food flavoring processing method according to the preferred embodiment of the present invention.

FIG. 3 is a block diagram of a pet food flavoring processing method according to the preferred embodiment of the present invention.

FIG. 4A is a perspective view of a pet food flavor enhancement processing system according to a preferred embodiment of the present invention.

FIG. 4B is another perspective view of the pet food flavor enhancement processing system according to the above preferred embodiment of the present invention.

FIG. 4C is an exploded view illustrating an automatic slurry coating assembly of the pet food flavor enhancement processing system according to the above preferred embodiment of the present invention.

FIG. 4D is a perspective view illustrating the automatic slurry coating assembly of the pet food flavor enhancement processing system according to the above preferred embodiment of the present invention.

FIG. 5 is another perspective view illustrating the automatic slurry coating assembly of the pet food flavor enhancement processing system according to the above preferred embodiment of the present invention.

FIG. 6 is a perspective view illustrating an air outlet for directing heat air into a pot of the pet food flavor enhancement processing system according to the above preferred embodiment of the present invention.

FIG. 7 is a perspective view illustrating a slurry supply assembly and the automatic slurry coating assembly of the pet food flavor enhancement processing system according to the above preferred embodiment of the present invention.

FIG. 8 is a sectional view illustrating the slurry supply assembly and the automatic slurry coating assembly of the pet food flavor enhancement processing system according to the above preferred embodiment of the present invention.

FIG. 9 is a schematic view illustrating a door of the housing being in an open state to expose the pot of the pet food flavor enhancement processing system according to the above preferred embodiment of the present invention.

FIG. 10 is a schematic view illustrating a heating assembly of the pet food flavor enhancement processing system according to the above preferred embodiment of the present invention.

FIG. 11 is a schematic view illustrating an alternative heating assembly of the pet food flavor enhancement processing system according to the above preferred embodiment of the present invention.

FIG. 12 is a perspective view illustrating a pulping unit of the pet food flavor enhancement processing system according to the above preferred embodiment of the present invention.

FIG. 13 is an exploded view illustrating the pulping unit of the pet food flavor enhancement processing system according to the above preferred embodiment of the present invention.

FIG. 14 is a perspective view illustrating a mincing element and a pulping driving mechanism of the pulping unit of the pet food flavor enhancement processing system according to the above preferred embodiment of the present invention.

FIG. 15 is another exploded view illustrating the pulping unit of the pet food flavor enhancement processing system according to the above preferred embodiment of the present invention.

FIG. 16 is a schematic view illustrating a pulping container, a water inlet slider element and a slurry feeding unit of the pet food flavor enhancement processing system according to the above preferred embodiment of the present invention.

FIG. 17 is a schematic view illustrating the connection between the mincing element and the pulping driving mechanism of the pulping unit of the pet food flavor enhancement processing system according to the above preferred embodiment of the present invention.

FIG. 18 is another schematic view illustrating the connection between the mincing element and the pulping driving mechanism of the pulping unit of the pet food flavor enhancement processing system according to the above preferred embodiment of the present invention.

FIG. 19 is a perspective view illustrating a weighting unit of the pet food flavor enhancement processing system according to the above preferred embodiment of the present invention.

FIG. 20 is a perspective view illustrating a pet food feeding mechanism of the pet food flavor enhancement processing system according to the above preferred embodiment of the present invention.

FIG. 21 is an exploded view illustrating the pet food feeding mechanism of the pet food flavor enhancement processing system according to the above preferred embodiment of the present invention.

FIG. 22 is a perspective view illustrating a feeding driving motor and a transmission shaft of the pet food feeding mechanism of the pet food flavor enhancement processing system according to the above preferred embodiment of the present invention.

FIG. 23 is a schematic view illustrating a cleaning assembly of the pet food flavor enhancement processing system according to the above preferred embodiment of the present invention, wherein a wastewater suction pipe is in an idle state.

FIG. 24 is a schematic view illustrating the cleaning assembly of the pet food flavor enhancement processing system according to the above preferred embodiment of the present invention, wherein the wastewater suction pipe is extended into the pot for wastewater suction.

FIG. 25 is a perspective view illustrating a water heat and a water pump of the cleaning assembly of the pet food flavor enhancement processing system according to the above preferred embodiment of the present invention.

FIG. 26 is a schematic view illustrating the process of coating a slurry material on a pet food raw material to form a flavor enhancement layer on the pet food raw material by the pet food flavor enhancement processing system according to the above preferred embodiment of the present invention.

### DETAILED DESCRIPTION OF THE PREFERRED EMBODIMENT

The following description is used to disclose the present invention so that those skilled in the art can implement the present invention. The preferred embodiments described below are only examples, and those skilled in the art can think of other obvious variations. The basic principles of the present invention defined in the following description can be applied to other embodiments, variations, improvements, equivalents, and other technical solutions that do not deviate from the spirit and scope of the present invention.

Those skilled in the art should understand that, in the disclosure of the present invention, the terms "longitudinal", "lateral", "up", "down", "front", "back", "left", "right", "vertical", "horizontal", "top", "bottom", "inside", "outside" and the like indicating the orientation or position relationship are based on the orientation or position relationship shown in the drawings, which are only for the convenience of describing the present invention and simplifying the description, rather than indicating or implying that the device or element referred to must have a specific orientation, be constructed and operated in a specific orientation. Therefore, the above terms should not be understood as limiting the present invention.

It is to be understood that the term "a" or “an” should be understood as "at least one" or "one or more", that is, in one embodiment, the number of an element may be one, while in another embodiment, the number of the element may be multiple, and the term "a" or “an” should not be understood as a limitation on the quantity.

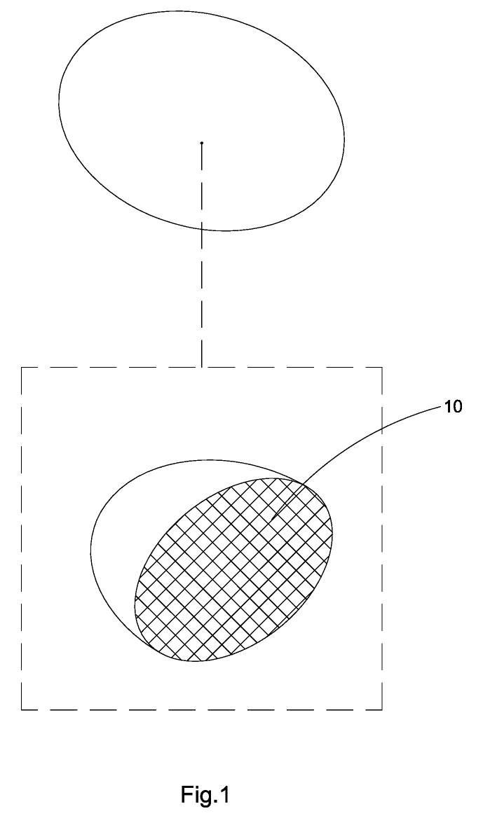

Referring to FIGS. 1 to 3, a pet food flavoring processing method according to a preferred embodiment of the present invention is illustrated. The pet food flavoring processing method is used for pet owners to prepare pet food processed food 1 by themselves. The pet food processed food 1 has a better taste and flavor, can better meet the taste needs of pets, can stimulate the pet's sense of smell and taste, thereby increasing the pet's appetite, especially for those picky eaters or those with poor appetite. In addition, the pet owner participates in the preparation of the pet food processed food 1. The pet owner adjusts the taste of the pet food processed food 1 according to the pet's feedback, thereby enriching the pet's diet while increasing the pet owner's fun and sense of accomplishment, so that the relationship between the pet and the owner can be further enhanced.

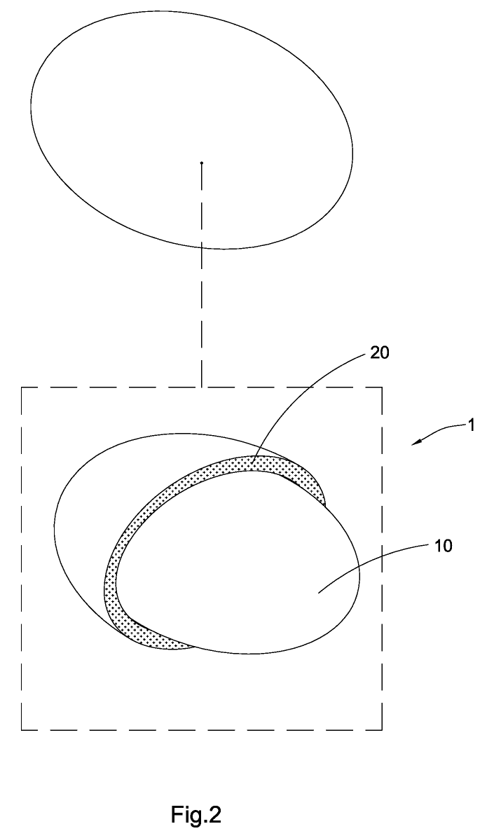

FIG. 1 is a cross-sectional view of a pet food according to a pet food flavoring processing method of the preferred embodiment of the present invention. FIG. 2 is a cross-sectional view of a pet food processed food 1 according to the pet food flavoring processing method of the preferred embodiment of the present invention. As shown in FIGS. 1 and 2, the pet food processed food 1 comprises a pet food raw material 10 and a flavor enhancement layer 20, wherein the flavor enhancement layer 20 is attached to the outside of the pet food raw material 10, and preferably, the flavor enhancement layer 20 is uniformly wrapped around the outside of the pet food raw material 10.

In particular, in the embodiment of the present application, the material of the pet food raw material 10 is not limited by the present application. The pet food raw material 10 can be implemented as traditional cat food or dog food available on the market. A person of ordinary skill in the art should know that based on the different types and individuals of pets, they have different preferences for the pet food raw materials 10 of different materials. In this regard, the pet owner can select a suitable pet food raw material 10 to prepare the pet food processed food 1.

The pet food raw material 10 can be puffed food, baked food, air-dried food, freeze-dried food, etc. according to its preparation process. Puffed food is made by grinding the raw material into powder and then putting it into the puffing machine for extrusion molding through high-temperature puffing process. Fresh meat is not added in the process, but meat powder and starch are generally added to facilitate molding. Finally, oil and some nutrients are sprayed to ensure the nutritional needs of pets.

To bake grains, the raw materials are first crushed, then pressed into shape under low temperature and low pressure, and then slowly baked. The baking process is not affected by high temperature, starch is generally not added, and the nutrients of the raw materials are basically not lost.

Air-dried food is made by air-drying food in a simulated natural environment. The raw materials are sliced and then air-dried at a certain temperature. It is basically made of fresh meat, and the temperature is not too high, so the nutrients in the ingredients themselves will basically not be lost. Generally, air-dried food is made by air-drying fresh meat to increase palatability.

Freeze-dried food is made by freezing and vacuum drying the raw materials at low temperature. Freeze-drying is generally divided into three main processes: pre-freezing, sublimation drying, and analytical drying. Sublimation and analytical drying are carried out under vacuum conditions, and freeze-drying is carried out at low temperatures and in a high vacuum state. Therefore, it is particularly suitable for many heat-sensitive substances, such as proteins, aromatic amino acids that constitute the natural flavor of meat, vitamins, etc., which will not be denatured or lose biological activity. Some easily oxidized substances are protected, retaining the color, aroma, taste and nutritional components of fresh food.

The raw materials of the pet food raw materials 10 may include but are not limited to pet food produced by brand manufacturers such as Royal, Purina, Pedigree, ProNer, Birridge, Myfood, Crave, Whiskas, and Soligo. The forms of the pet food raw materials 10 include but are not limited to flakes, blocks, strips, balls, etc., and their shapes include but are not limited to round, square, triangle, hexagon, plum blossom, etc.

In particular, in the embodiment of the present application, in order to solve the problem that traditional pet food often cannot meet the needs of some pets in terms of taste, the pet food processed food 1 in the embodiment of the present application adopts an optimized processing method suitable for pet owners or managers of pet management centers to prepare pet food with enhanced taste, rich taste and nutrition based on the pet food raw materials 10.

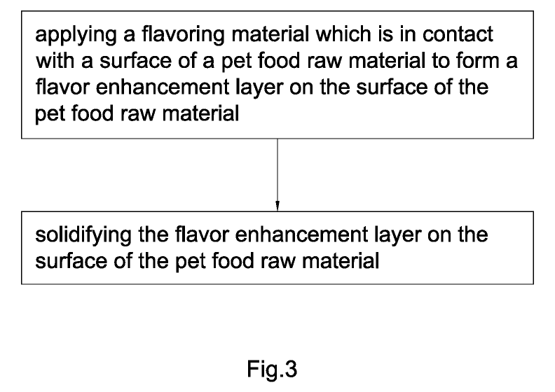

FIG. 3 is a block diagram of the pet food flavoring processing method according to the preferred embodiment of the present invention. In this embodiment, the pet food flavoring processing method includes: preparing a flavoring material; contacting the flavoring material with the surface of the pet food raw material 10 to form the flavor enhancement layer 20; and curing the flavor enhancement layer 20 to make it adhere to the surface of the pet food to obtain the pet food processed food 1.

In the step of preparing the flavoring material, more specifically, the flavor enhancement layer 20 is formed by forming a flavoring material on the surface of the pet food raw material 10 and curing it. The flavoring material can be implemented as liquid, slurry, solid or gas.

In the process of preparing the flavoring material, the method of preparing the flavoring material comprises but is not limited to forming the flavoring material by crushing the flavoring raw material and adding water to pulp; forming the flavoring material by crushing the flavoring raw material and adding water to squeeze out the juice; forming the flavoring material by cutting and grinding the flavoring raw material to make it into powder or forming the flavoring material by collecting the smell of the flavoring raw material, for example, when the flavoring raw material is meat, forming the flavoring material by collecting the meat aroma.

Flavoring raw materials may comprise but is not limited to meat, vegetables, fruits or dairy products. Preferably, the tendons of meat or the stems and roots of vegetables need to be removed to facilitate the pulping of the raw materials. In a possible implementation of the blending and pulping method, the meat is first cleaned and cut into small pieces, minced by a meat grinder configured in the processing equipment of the present invention, and after adding an appropriate amount of clean water, stirred evenly by a stirring device to form meat pulp.

It is understood that meat comprises but is not limited to pork, beef, mutton, chicken, duck, goose, fish, shrimp, crab, shellfish, etc. Vegetables comprise but are not limited to pumpkin, potato, sweet potato, etc. Green leafy vegetables can be blended into juice and added to the meat paste to increase the flavor. Fruits comprise but are not limited to apples, oranges, bananas, etc. Dairy products comprise but are not limited to milk powder, milk, cheese, condensed milk, etc.

Based on this, the pet food flavoring processing method can increase the nutritional components of the pet food processed food 1, such as protein, fat, minerals, vitamins, etc., by adding the flavor enhancement layer 20 outside the pet food raw material 10. In addition, the addition of the flavor enhancement layer 20 not only increases the flavor, but also improves the taste of the pet food processed food 1, making it crispier or softer, and can be adjusted according to the preferences of different pets.

It is worth mentioning that when the material of the flavoring raw material is meat, the viscosity of the flavoring material formed by crushing and pulping is relatively high, which is conducive to the coating of the flavoring material on the surface of the pet food raw material 10, so that the flavoring material can be evenly wrapped on the outside of the pet food raw material 10. When the material of the flavoring raw material is vegetables, the viscosity of the flavoring material formed by crushing and pulping is relatively low. In the process of preparing the flavoring material and the pet food raw material 10, food-grade gelatin, starch, lecithin or a combination thereof can also be added to help viscosity. The viscosity of the flavoring material is increased, which is conducive to the even wrapping of the flavoring material on the outside of the pet food raw material 10. In addition, the viscosity of the flavoring material can also be increased by mixing the flavoring raw materials of meat and vegetables.

Next, the flavoring material is used to form the flavor enhancement layer 20 on the surface of the pet food raw material 10. Here, the flavor enhancement layer 20 may be formed by, but is not limited to, spraying, soaking, brushing, stirring, vibrating or rolling.

For example, in a possible implementation, the flavor enhancement layer 20 can be applied to the pet food raw material 10 by soaking. Specifically, the pet food raw material 10 is placed in a hollow mold, and the pet food raw material 10 and the hollow mold are immersed in a container storing the flavoring material. After soaking for a predetermined time, the pet food raw material 10 and the hollow mold are taken out. At this time, the flavoring material is evenly wrapped on the outside of the pet food raw material 10. Finally, the excess flavoring material is collected and put back into the container, and the step of coating the flavoring material on the surface of the pet food raw material 10 to form the flavor enhancement layer 20 can be completed. The soaking coating method is suitable for pet food raw materials 10 of various shapes. For example, for the bone-shaped pet food raw material 10 required by pet dogs, the flavor enhancement layer 20 can be evenly coated on the pet food raw material 10 by soaking. When the flavoring material is a liquid or a slurry, the flavor enhancement layer 20 can be applied to the pet food raw material 10 by soaking.

For another example, in another possible implementation, the flavor enhancement layer 20 can be applied to the pet food raw material 10 by spraying. Specifically, the pet food raw materials 10 are neatly arranged in the positioning holes of a positioning mold, the flavoring material is poured into a spray gun, and the flavoring material is evenly sprayed onto the outer surface of the pet food raw material 10 by the spray gun to form the flavor enhancement layer 20. It is worth mentioning that when the flavoring material is a gas, liquid or slurry, the flavor enhancement layer 20 can be applied to the pet food raw material 10 by spraying.

In another possible implementation, the flavor enhancement layer 20 can be applied to the pet food raw material 10 by brushing. Specifically, the pet food raw materials 10 are neatly arranged in the positioning holes of the positioning mold, and the flavoring material is evenly brushed onto the outer surface of the pet food raw material 10 by a brush to form the flavor enhancement layer 20. When the flavoring material is a liquid or slurry, the flavor enhancement layer 20 can be applied to the pet food raw material 10 by brushing. The spraying and brushing coating methods are applicable to the pet food raw materials 10 of various shapes, such as round, square or long strips.

For another example, in another possible implementation, the flavor enhancement layer 20 can be applied to the pet food raw material 10 by rolling. Specifically, the pet food raw material 10 is placed in a rolling device, and the flavoring material is uniformly poured into the rolling device. By rolling in the rolling device, the flavoring material is uniformly rolled and adsorbed onto the outer surface of the pet food raw material 10 to form the flavor enhancement layer 20. The rolling coating method has a high degree of automation and is convenient for pet owners to operate. When the flavoring material is solid, liquid or slurry, the flavor enhancement layer 20 can be applied to the pet food raw material 10 by rolling.

In addition, in the step of drying and curing the flavor enhancement layer 20 so that the flavor enhancement layer 20 adheres to the surface of the pet food raw material 10, the pet food processed food 1 is obtained. Here, the drying and curing treatment can be carried out by using an oven or other device to perform drying and curing treatment, so that the flavor enhancement layer 20 is further matured and firmly fixed on the surface of the pet food raw material 10. In this regard, those skilled in the art should understand that the drying and curing treatment of the flavor enhancement layer 20 is not a limitation of the present invention.

In the embodiment of the present application, the temperature of the drying and curing treatment of the flavor enhancement layer 20 is set to 50 ° C to 80 °C, and the duration is 10 to 30 minutes. It is ensured that the flavor enhancement layer 20 can be evenly fixed on the outside of the pet food raw material 10. By selecting the appropriate temperature and time for the drying and curing treatment, the loss of nutrients and water in the processed pet food 1 can be avoided, and the processed pet food 1 can be ensured to have the best flavor, improve the taste of the pet food, and make it more crispy or tender.

In addition, in the embodiment of the present application, preferably, the thickness of the flavor enhancement layer 20 is 0.1 to 5 mm. The flavor enhancement layer 20 of suitable size makes the overall size of the processed pet food 1 meet the actual needs. The appropriate ratio of the flavor enhancement layer 20 and the pet food raw material 10 can be ensured, thereby ensuring that the pet takes in balanced nutrition. On the other hand, the appropriate thickness of the flavor enhancement layer 20 helps to control the production cost, which can meet the taste requirements of the pet without increasing unnecessary costs due to excessive seasonings.

In summary, the pet food processed food 1 produced by the pet food flavoring processing method has a better taste and flavor than the traditional pet food raw material 10, can better meet the taste needs of pets, can stimulate the pet's sense of smell and taste, thereby increasing the pet's appetite, especially for those picky eaters or those with poor appetite. At the same time, by adding the flavor enhancement layer 20 to the pet food raw material 10, the nutritional content of the pet food processed food 1 can be increased, making the pet healthier.

Accordingly, according to one embodiment, the present invention provides a pet food flavoring processing device for pet owners to coat the purchased pet food raw materials 10 with a new flavor layer according to the preferences of their pets, comprising a mincing device, a hollow mold, a soaking device, and a curing device, wherein the mincing device minces meat or vegetables and makes the flavoring material in a slurry state after adding water, the hollow mold is used to accommodate the pet food raw materials 10, the soaking device is used to coat the pet food raw materials 10 in the hollow mold with the flavoring material, and the curing device can dry and solidify the flavoring material coated on the pet food raw materials 10 to finally form the pet food processed food 1.

According to one embodiment, the present invention provides a pet food flavoring processing equipment for pet owners to coat a new flavor layer on the basis of the purchased pet food raw material 10 according to the pet's preferences, comprising a mincing device, a positioning device, a spray gun, and a curing device, wherein the mincing device minces meat or vegetables and makes the flavoring material into a slurry after adding water, the positioning device is used to accommodate and position the pet food raw material 10, the spray gun is used to spray the pet food raw material 10 in the positioning mold with the flavoring material, and the curing device can dry and solidify the flavoring material coated on the pet food raw material 10 to finally form the pet food processed food 1.

According to one embodiment, the present invention provides a pet food flavoring processing equipment for pet owners to coat the purchased pet food raw materials 10 with a new flavor layer according to the preferences of their pets, comprising a mincing device, a positioning device, a brushing device, and a curing device, wherein the mincing device minces meat or vegetables and makes the flavoring material in a slurry after adding water, the positioning device is used to accommodate and position the pet food raw materials 10, the brushing device is used to brush the flavoring material on the pet food raw materials 10 in the positioning mold, and the curing device can dry and solidify the flavoring material coated on the pet food raw materials 10 to finally form the pet food processed food 1.

According to one embodiment, the present invention provides a pet food flavoring processing equipment for pet owners to coat a new flavor layer on the basis of the purchased pet food raw material 10 according to the pet's preferences, comprising a mincing device, a rolling stirring device, and a curing device, wherein the mincing device minces meat or vegetables and makes the flavoring material into a slurry after adding water, the rolling stirring device is used to accommodate the pet food raw material 10, and the flavoring material is added to the rolling stirring device, the rolling stirring device drives the pet food raw material 10 to roll in its inner cavity so that it is evenly coated with the flavoring material, and the curing device can dry and solidify the flavoring material coated on the pet food raw material 10 to finally form the pet food processed food 1.

It can be understood that the pet food flavoring processing equipment in the above embodiments can form a set of kits or be integrated into the same machine. In this way, the pet owner only needs to select the appropriate ingredients, and the subsequent processing process can be completed automatically by the machine, which is convenient for the pet owner to operate.

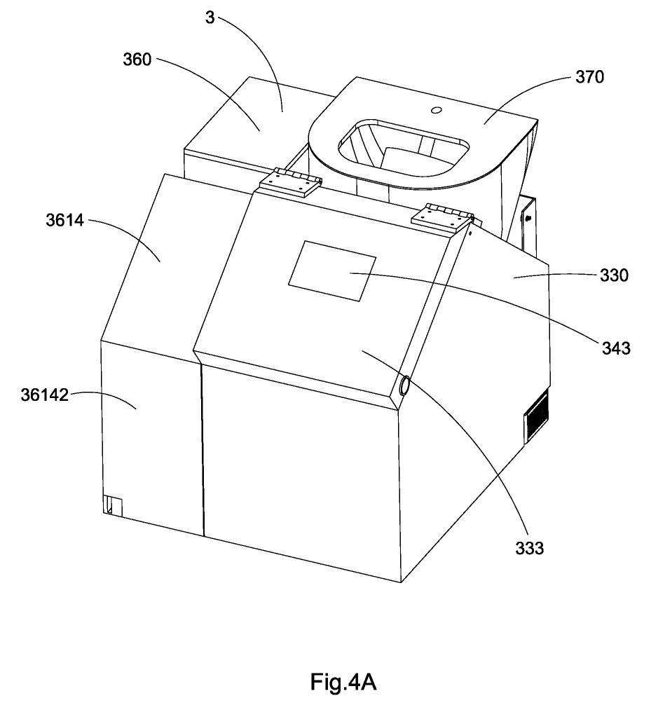

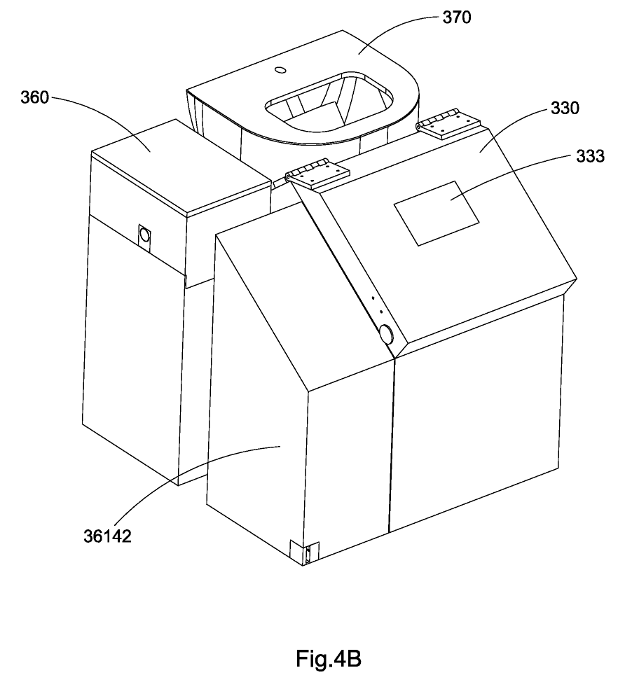

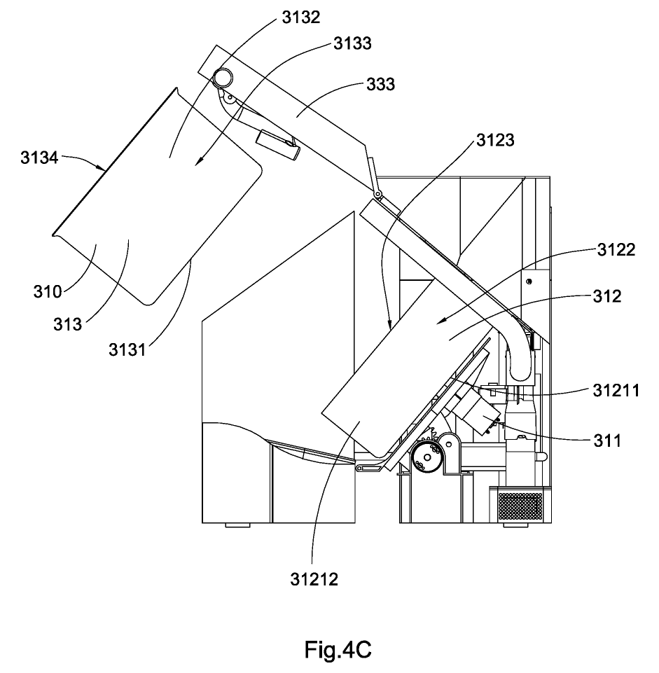

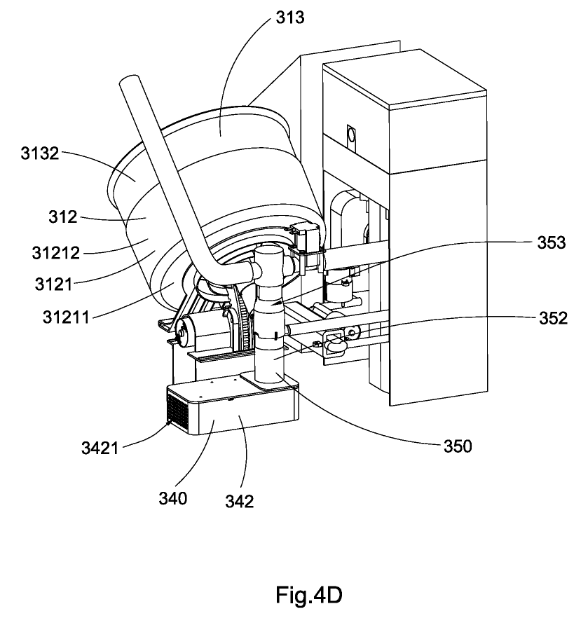

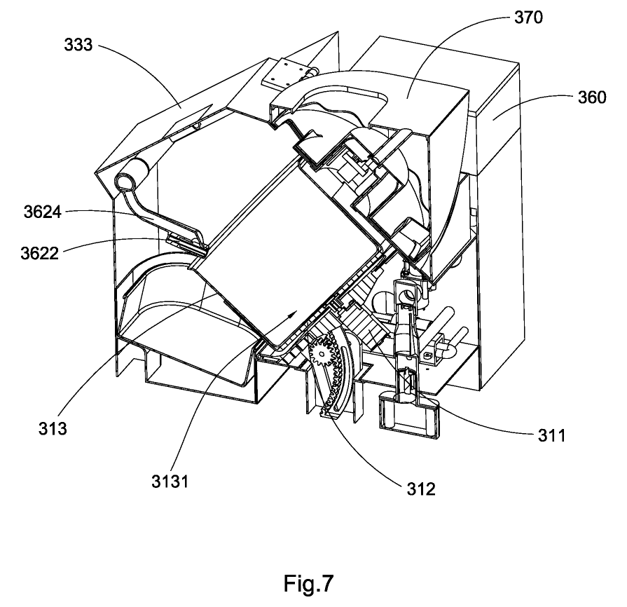

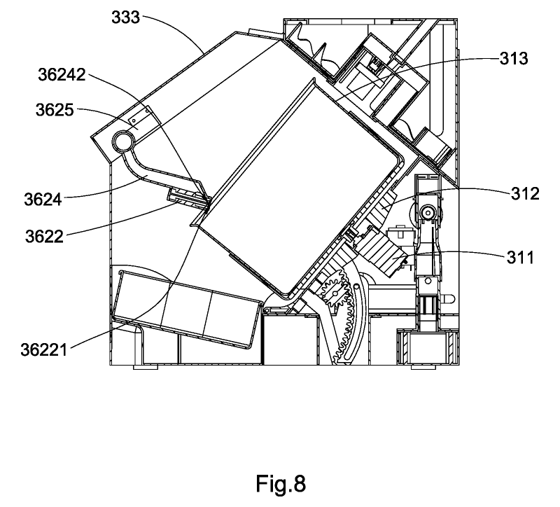

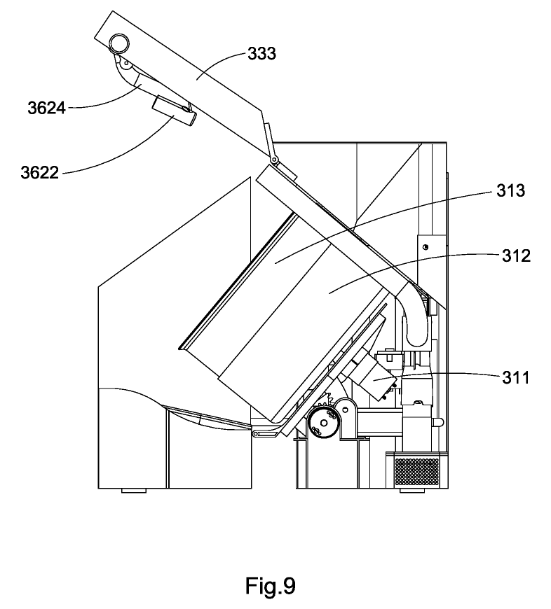

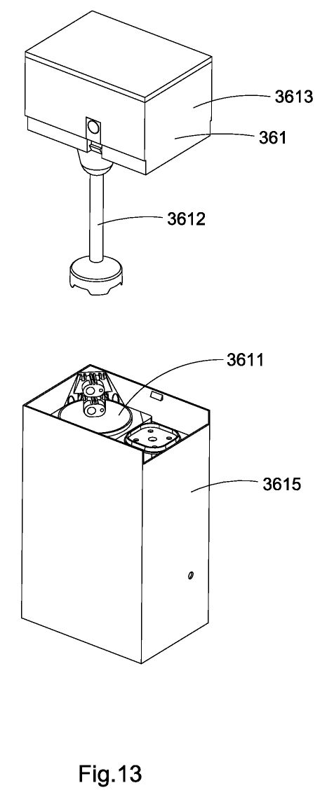

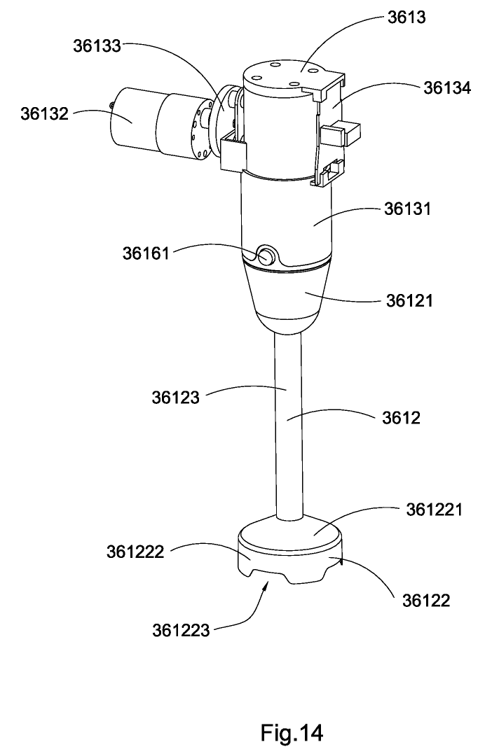

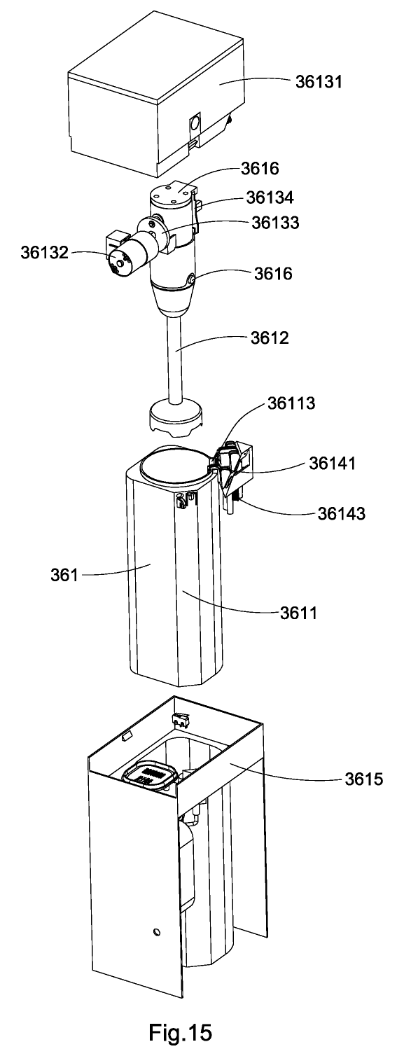

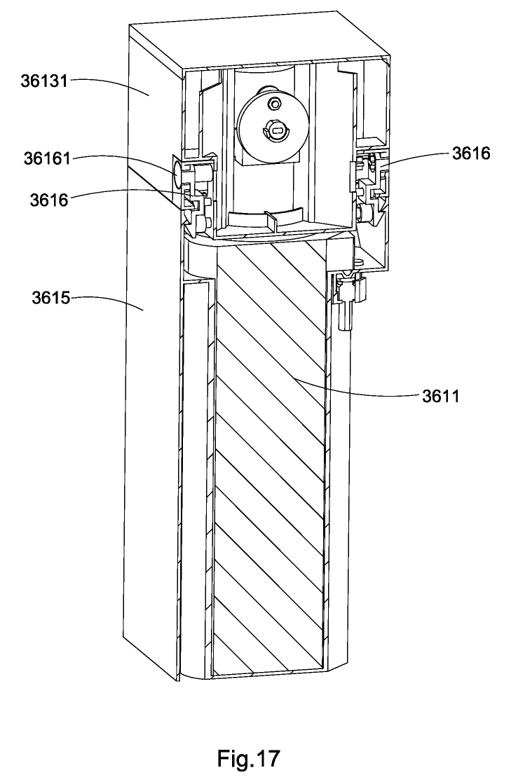

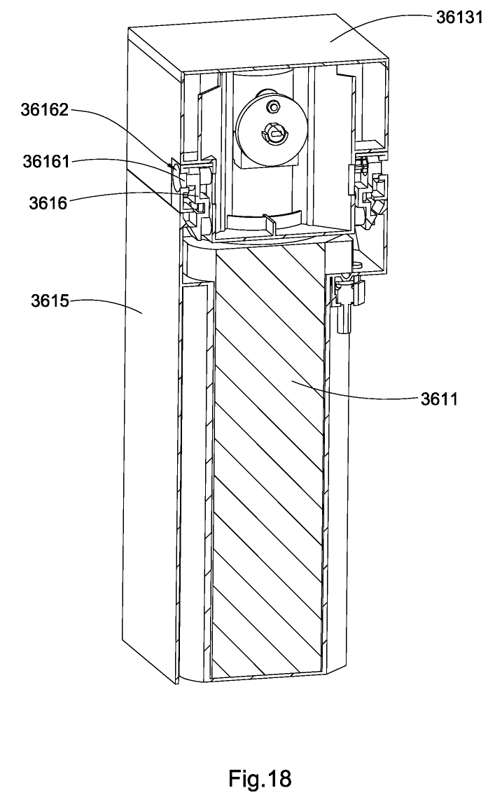

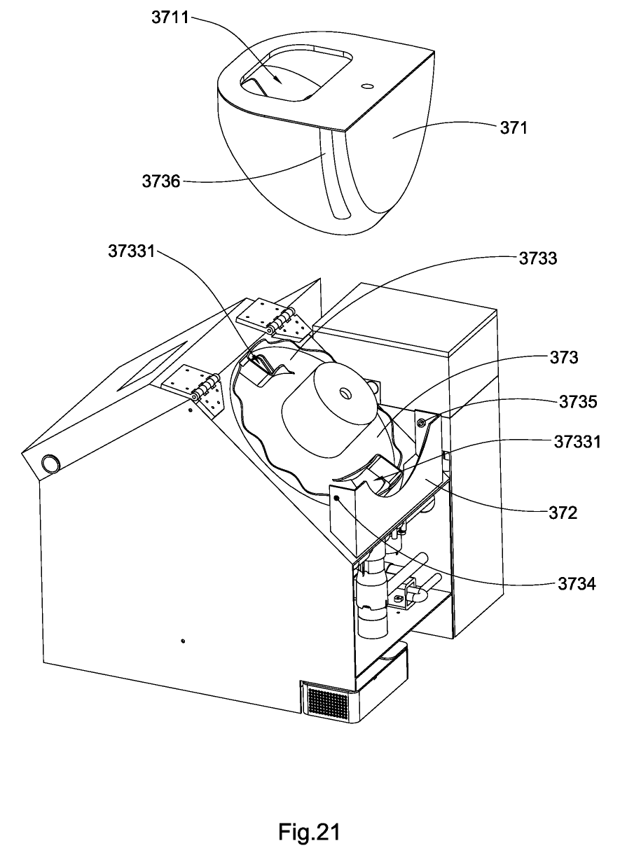

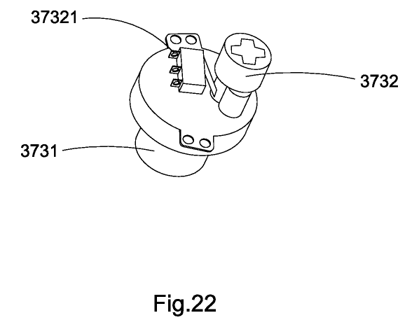

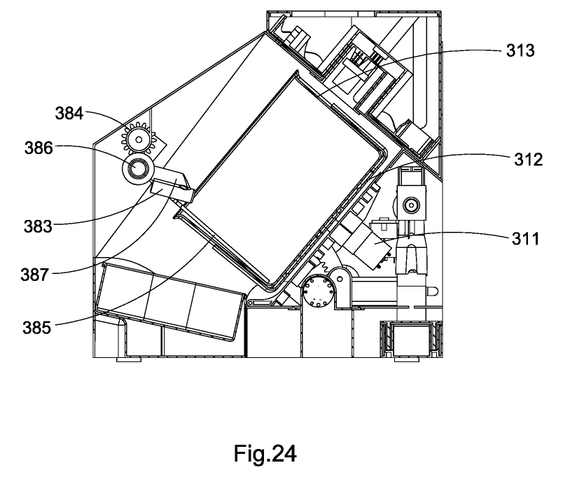

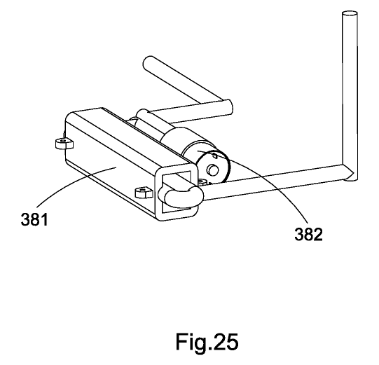

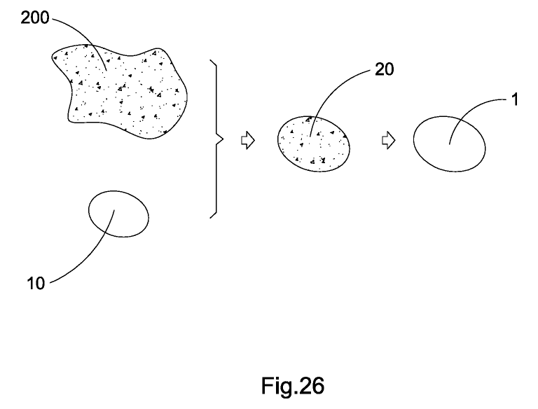

Referring to FIGS. 4A to 26 of the drawings, a pet food flavor enhancement processing system 3 according to a preferred embodiment of the present invention is illustrated. The pet food flavor enhancement processing system 3 comprises an automatic slurry coating assembly 310 for coating a slurry material 200 on a surface of the pet food raw material 10, and a heating assembly 320 for heating the slurry material 200 on the surface of the pet food raw material 10 to form a flavor enhancement layer 20 on the surface of the pet food raw material 10.

The pet food flavor enhancement processing system 3 is designed to allow pet owners at home or staff at pet care centers to enhance the palatability and nutritional value of pet food raw material 10 by applying and fixing the flavor enhancement layer 20 onto the surface of the pet food raw material 10. The pet food flavor enhancement processing system 3 integrates several components that perform the tasks of coating and curing in an automated and efficient manner.

The pet food raw material 10 refers to the base component of the pet food before flavor enhancement, and may be implemented in various commercial or custom-prepared forms. It serves as the core substrate onto which the flavor enhancement layer 20 is applied. The pet food raw material 10 is not limited to a specific formulation or shape and may be selected based on the dietary preferences or nutritional needs of different pets.

In preferred embodiments, the pet food raw material 10 may be selected from a wide range of conventional pet food products, including but not limited to puffed food, baked food, air-dried food, and freeze-dried food. These materials may be commercially available products such as kibble, pellets, or snacks produced by well-known brands (e.g., Royal, Purina, Pedigree, Whiskas, etc.), or custom-manufactured bases designed for at-home processing.

The shape and texture of the pet food raw material 10 may also vary and include forms such as flake, block, strip, ball, or other geometric configurations like round, square, triangular, hexagonal, or flower-shaped structures. This variety ensures compatibility with different coating and drying methods used in the flavoring process. As a typical example, each pet food raw material 10 can be a pet food ball. The pet food flavor enhancement processing system 3 is arranged to coat the flavor enhancement layers 20 on plurality of pet food balls respectively.

Depending on the processing technique, the pet food raw material 10 may be composed primarily of meat powder, starch, fresh meat meat, vegetables and may undergo specific preparation methods such as puffing, baking, air-drying and free-drying. In a puffing process, powdered raw ingredients are expanded using high temperature and pressure. The baking process involves low-temperature shaping and gradual heating to preserve nutrients. The air-drying process uses gentle heat to remove moisture while maintaining nutritional integrity. In freeze-drying process, raw ingredients are frozen and then dehydrated under vacuum to retain flavor, structure, and sensitive nutrients.

The pet food raw material 10 provides the structural base for flavor enhancement and may contribute to the final product's mouthfeel, texture, and nutrition. By selecting different types and shapes of pet food raw materials 10, pet owners or processors can tailor the finished pet food product 1 to match specific preferences of pets, including chewing behavior, dietary sensitivity, and taste appearance.

The slurry material 200 is preferably made from meat, vegetables, fruits, or dairy products, which are minced and blended with water to form a viscous paste or slurry. This slurry can also be enriched with additional nutrients such as vitamins, minerals, and oils. The automatic slurry coating assembly 310 may use various methods, such as spraying, brushing, soaking, or rolling, to evenly coat the slurry material 200 onto the surface of pet food raw material 10 in the form of flakes, blocks, strips, or pellets.

Once the slurry material 200 is applied, the heating assembly 320 cures the slurry through controlled drying, preferably at 50°C-80°C for 10 minutes-30minutes. This ensures the slurry material 200 adheres firmly and evenly, forming the flavor enhancement layer 20 with a thickness of 0.1mm-5.0mm.

The pet food flavor enhancement processing system 3 allows the formation of the flavor enhancement layer 20 that can be customized according to the pet’s preferences, such as meaty, fishy, or vegetable notes. The enhanced aroma and taste stimulate the pet’s sense of smell and taste, increasing appetite, particularly for picky eaters or pets with poor appetite.

The slurry material 200 may contain high-protein meat, essential fats, vitamins, and minerals. Coating the pet food with this nutrient-rich slurry layer adds to the overall nutritional value without altering the core composition of the original food.

The automatic coating mechanism ensures a precise and uniform distribution of the slurry across the surface of each pet food piece, resulting in consistent product quality and palatability. The integrated heating assembly 320 effectively dries and sets the flavor enhancement layer 20 without degrading nutritional content, preserving sensitive components like proteins and amino acids while ensuring the layer remains stable during storage and handling.

One of the key innovations of the present invention lies in enabling pet owners themselves to prepare enhanced pet food at home. By involving owners in the preparation process, the system promotes interaction between pet and owner, enhancing emotional bonding and user satisfaction. In other words, pet owners can experiment with a variety of ingredients to see which flavors their pets prefer, and create pet food in different flavors tailored to their pets’ tastes.

In this embodiment, as shown in FIGS. 4C to 9, the automatic slurry coating assembly 310 comprises a rotation motor 311, a rotation pot base 312 coupled to the rotation motor 311 and a pot 313 coupled to the rotation pot base 312 to receive the slurry material 200 and the pet food raw material 10. When the rotation motor 311 is rotating, the rotation pot base 312 is driven to rotate to drive the pot 313 to rotate, so as to allow the slurry material 200 to be coated on the surface of the pet food raw material 10.

In operation, the pet food raw material 10 and the slurry material 200 are placed into the pot 313. Upon activation, the rotation motor 311 drives the rotation pot base 312, thereby causing the pot 313 to rotate around a central axis. The rotation generates centrifugal force and mixing turbulence, which causes the slurry material 200 to be evenly distributed and coated on the outer surface of each piece of the pet food raw material 10. The internal surface of the pot 313 may be smooth or optionally include mixing ribs or baffles to enhance the tumbling and mixing action during rotation, further improving coating uniformity.

The pot 313 is preferably removably mounted within the pot base 312, allowing for convenient detachment, cleaning, and replacement by the user. This configuration is especially suitable for home users or pet management center staff, providing an efficient and hygienic solution for preparing customized, flavor-enhanced pet food.

The rotational mixing action ensures that the slurry material 200 is evenly coated on the entire surface of the pet food raw material 10. This results in consistent flavor distribution and improved palatability of the final pet food product.

Once the ingredients are placed into the pot 313, the user simply activates the rotation motor 311. The system automatically performs the coating process, minimizing manual intervention and reducing user workload. The tumbling and centrifugal motion created by the rotating pot improves contact between the slurry material 200 and the food surface of the pet food raw material 10, allowing better absorption or adhesion of the slurry material 200, especially when the slurry has high viscosity.

The rotation-based coating process is suitable for pet food raw materials 10 of various shapes, such as balls, blocks, strips and flakes, ensuring compatibility with a wide range of commercial pet food types.

The rotation pot base 312 can be embodied to have a pot like structure which comprises a rotation container 3121 having a receiving chamber 3122 and an opening 3123 communicated to the receiving chamber 3122. The pot 313 is detachably disposed into the receiving chamber 3122 of the rotation pot base 312 through the opening 3123.

The pot 313 comprises a bottom wall 3131 and a surrounding wall 3132 connected to the bottom wall 3131 to define an inner chamber 3133 having an access opening 3134. The rotation container 3121 comprises a bottom surface 31211 and a surrounding surface 31212 connected to the bottom surface 31211 to define the receiving chamber 3122. The surrounding surface 31212 of the rotation container 3121 is matched with the surrounding wall 3132 of the pot 313, and when the pot 313 is disposed into the rotation container 3121, no connection structure is required to be provided between the pot 313 and the rotation container 3121, the surrounding surface 31212 of the rotation container 3121 is in frictional contact with the surrounding wall 3132 of the pot 313, so that the rotation container 3121 can drive the pot 313 to rotate.

This structural arrangement allows for efficient torque transmission from the rotation motor 311 to the pot 313 without requiring rigid fastening or complex couplings. The friction-fit interface between the rotation container 3121 and the pot 313 ensures easy insertion and removal, enabling tool-free cleaning or replacement of the pot 313. The matched contours reduce vibration or wobbling during rotation, ensuring stable and uniform coating of the slurry material 200.

During this rotational motion of the pot 313, the slurry material 200, which is placed together with the pet food raw material 10 inside the inner chamber 3133 of the pot 313, is subjected to centrifugal force and dynamic tumbling action. The rotational movement causes the pet food raw material 10 to move along the inner surface of the pot and tumble repeatedly within the slurry material 200.

This continuous and multidirectional movement promotes uniform contact between the slurry material 200 and the entire outer surface of each piece of the pet food raw material 10. The viscosity of the slurry material 200 allows it to adhere to the surface of the pet food raw material 10 during this process. The pot 313 may have a smooth inner surface. Alternatively, the coating action can be further enhanced by the geometry of the pot and, optionally, by the use of internal baffles or ribs, which increase turbulence and mixing efficiency.

As a result, the slurry material 200 becomes evenly distributed and effectively coated over the surface of the pet food raw material 10, forming a preliminary flavor enhancement layer that can subsequently be cured or dried in a downstream processing step to form a stable, adherent outer layer.

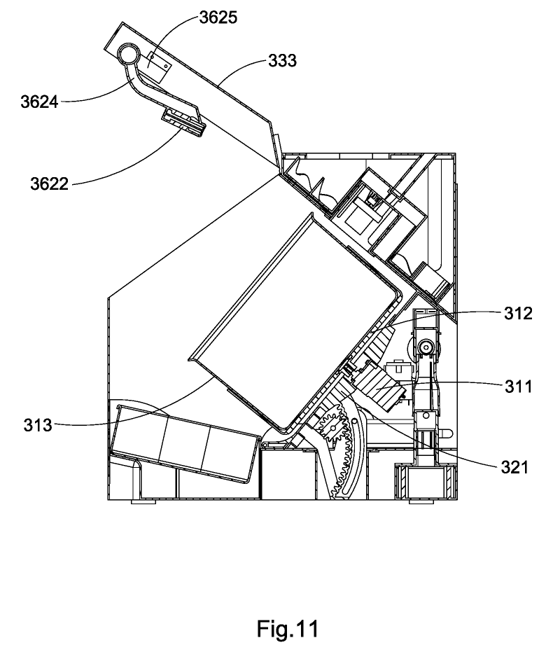

The heating assembly 320 may comprise a heating element 321 which is attached to the rotation pot base 312 or the pot 313, so as to heat the slurry material 200 on the surface of the pet food raw material 10, as shown in FIG. 11, so as to cure the slurry material 200 to form the favor enhancement layer 20 on the surface of the pet food raw material 10.

The heating assembly 320 is adapted to dry the slurry material 200, promoting solidification and adhesion of the flavor enhancement layer 20. In certain embodiments, the heating process may also partially or fully cook the slurry material 200, further enhancing the aroma, texture, and digestibility of the final coated pet food product.

In this embodiment, the pet food flavor enhancement processing system 3 comprises a housing 330 for mounting the automatic slurry coating assembly 310 and the heating assembly 320, a control assembly 340 for controlling the operation of the pet food flavor enhancement processing system 3 and an air blower assembly 350 which comprises an air blower 351 and a blower housing 352. The air blower 351 is disposed in a blower chamber 353 of the blower housing 352 for generating an air flow.

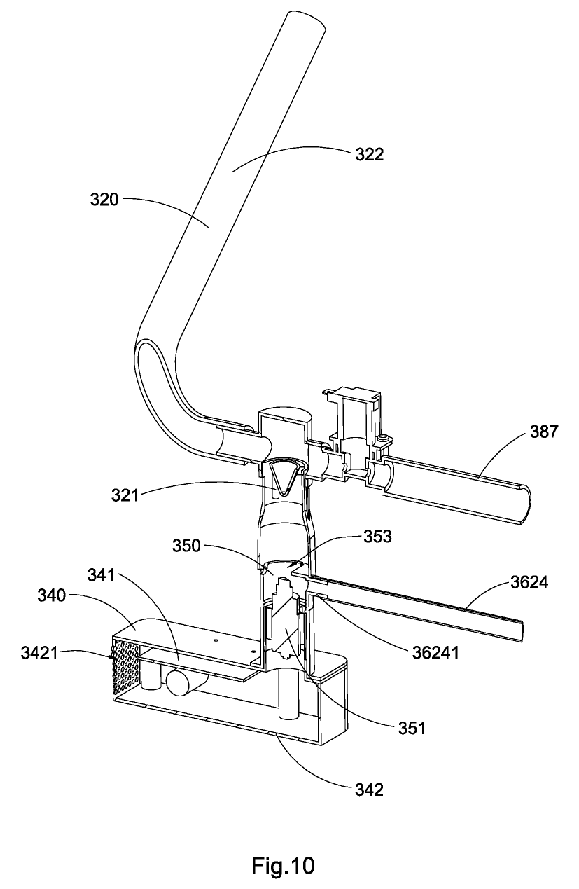

As shown in FIG. 10, the heating assembly 320 comprises a heating element 321 which is disposed in the blower housing 352 and positioned in front of the air blower 351 for heating the air from the air blower 351, and a heat air duct 322 for guiding heated air to the pot 313. The heat air duct 322 is configured to direct heated air toward the pet food raw material 10 that has been coated with the slurry material 200, while the heating element 321 is configured to generate thermal energy to facilitate the drying and curing of the slurry material 200. Through the combined operation of the drying air flow and the heating element 321, the flavor enhancement layer 20 formed by the slurry material 200 on the surface of the pet food raw material 10 can be efficiently solidified, thereby forming a stable and adherent outer coating.

The control assembly 340 comprises a control circuit board 341 and a circuit board housing 342 for storing the control circuit board 341. The heating element 321 can be embodied as a electric heating wire which is electrically connected to the control circuit board 341. The control circuit board 341 is configured to regulate the power supply to the heating element 321, thereby enabling precise control over the heating temperature and duration for effective drying and curing of the slurry material 200. Alternatively, the heating element 321 can be but not limited to a ceramic heating plate, a positive temperature coefficient heating member, an infrared heating member.

The circuit board housing 342 is connected to the blower housing 352 and has one or more air inlets 3421 communicated to the blower chamber 353 of the blower housing 352. The control circuit board 341 is arranged along the air intake path, such that incoming air flows over the control circuit board 341, thereby providing active cooling to the control circuit board 341 during operation.

The housing 330 has a cavity 331 for receiving the pot 313 and the rotation pot base 312. An air outlet 332 is formed in the housing 330 and is communicated to the cavity 331 and the heat air duct 322. The air outlet 332 is positioned obliquely above the pot 313, and is oriented to direct heated air into the interior of the pot 313. The arrangement of the air outlet 313 is such that it does not interfere with the removal path of the pot 313, thereby ensuring both effective heating and unobstructed disassembly or replacement of the pot 313.

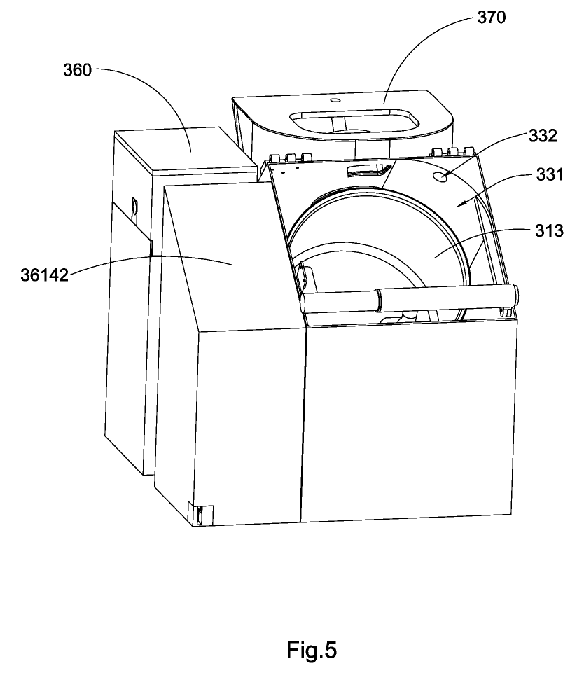

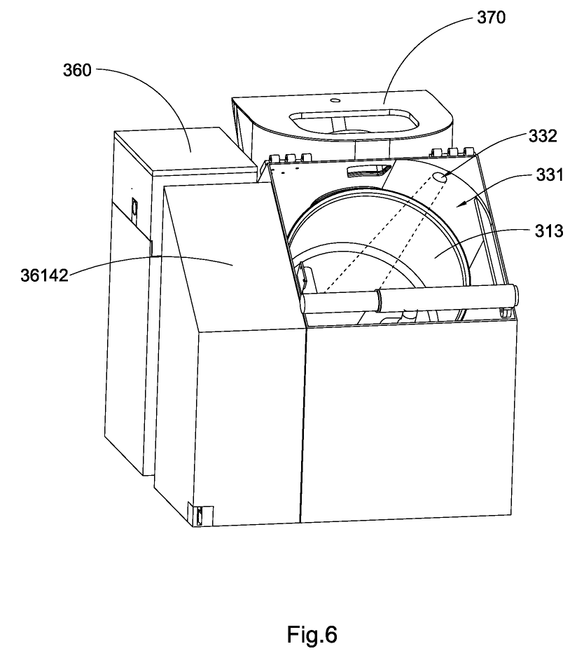

As shown in FIGS. 5 and 6, by positioning the air outlet 332 obliquely above the pot 313 and directing heated air into the interior, the system ensures that thermal energy is concentrated where it is most effective, that is on the surface of the slurry-coated pet food raw materials 10. This enhances the drying and curing efficiency of the flavor enhancement layer 20.

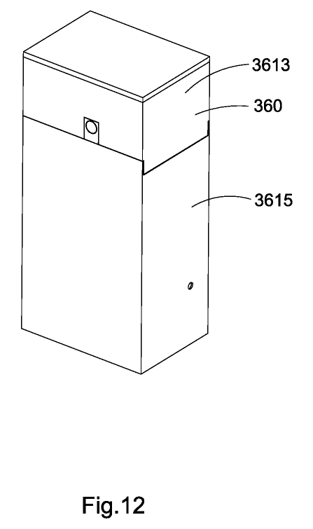

The slurry material 200 and the pet food raw materials 10 can be manually added into the pot 313. Preferably, the pet food flavor enhancement processing system 3 further comprises a slurry supply assembly 360 for automatically supplying the slurry material 200 to the pot 313 and a pet food feeding mechanism 370 for automatically feeding the pet food raw materials 10 to the pot 313, as shown in FIGS. 12 to 19.

More specifically, the slurry supply assembly 360 comprises a pulping unit 361 for preparing the slurry material 200 and a slurry feeding unit 362 for feeding the slurry material 200 to the pot 313. The pulping unit 361 comprises a pulping container 3611 for receiving the raw material of the slurry material 200, a mincing element 3612 for mincing the raw material of the slurry material 200, a pulping driving mechanism 3613 for driving the movement of the mincing element 3622, a water feeding unit 3614 for feeding water into the pulping container 3611.

The integrated pulping unit 361 allows raw ingredients to be minced, blended, and diluted within the pulping container 3611, reducing processing time and eliminating the need for separate mixing or grinding equipment. Pet owners or operators can freely select and combine different ingredients, such as meat, vegetables, and fruits, and adjust the water input to create personalized flavor profiles tailored to a pet’s taste preferences.

The slurry supply assembly 360 further comprises a container base 3615, and the pulping container 3611 is preferred to be detachably mounted to the container base 3615, so that the pulping container 3611 can be detached from the container base 3615 for loading the raw material of the slurry material 200 or to be cleaned. The pulping driving mechanism 3613 also can be detachably mounted to the container base 3615.

The mincing element 3612 can be locked to the pulping driving mechanism 3613 by a locking unit 3616 which can be be implemented as a snap-fit structure. The locking mechanism is configured to mechanically fasten the mincing element 3612 to the pulping driving mechanism 3613 during operation, ensuring stable engagement and preventing separation. In an example, the pulping driving mechanism 3613 comprises a shell 36131, the locking unit 3616 comprises one or more snap-fit latches 36161, which allow for tool-free assembly and disassembly from one or more locking holes 36162 in the shell 36131 of the pulping driving mechanism 3613, thereby facilitating cleaning, maintenance, and component replacement. When the latches 36161 are pressed, the locking state between the mincing element 3612 and the pulping driving mechanism 3613 can be detached.

The mincing element 3612 comprises an upper end portion 36121 for mounting with the shell 36131 of the pulping driving mechanism 3613, a lower mincing head 36122 for mincing the raw material of the slurry material 200, and an elongated arm 36123 extended between the upper end portion 36121 and the lower mincing head 36122. The lower mincing head 36122 is illustrated to comprises a top wall 361221 and an enclosing wall 361222 with a plurality of indented grooves 361223, so as to allow the enclosing wall 36122 to form cutting ridges for enabling the lower mincing head 36122 to shear, crush, or grind the raw material into fine particles during rotation or oscillation. The structural combination of the top wall 361221 and the enclosing wall 36122 with the indented groove 361223 creates a chambered mincing region with enhanced cutting efficiency and reduced risk of clogging. The person of ordinary skilled in the art should understand that the structure of the mincing element 3612 is just an example and is not limiting in the present invention. The mincing element 3612 can be embodied to comprise other types of blades.

The pulping driving mechanism 3613 comprises a driving motor 36132, and a crank-slider linkage mechanism 36133 mounted to the shell 36131, and a mincing control circuit board 36134 electrically connected to the driving motor 36132 and the control circuit board 341. The driving motor 36132 is configured to drive the mincing element 3612 to perform a reciprocating up-and-down motion via the crank-slider linkage mechanism 36133. In one embodiment, the reciprocating stroke of the mincing element 3612 is approximately 30 mm, allowing the mincing element 3612 to effectively mince the raw material within the pulping container 3611 through repeated vertical displacement. The use of the crank-linkage mechanism 36133 ensures stable transmission of motion and provides consistent cutting force during each stroke.

The pulping container 3611 is provided with a slurry supply duct 36111 which comprises an outlet tube 36112. The inlet of the slurry supply duct 36111 is preferred to be at a bottom of the pulping chamber of the pulping container 3611. The slurry feeding unit 362 comprises a pump 3621, a feeding pipe 3622 and a connector 3623 connected to the outlet tube 36112 when the pulping container 3611 is mounted on the container base 3615. Accordingly, the connector 3623 is attached to the container base 3615 and is connected to the pump 3621 and the feeding pipe 3622. In this embodiment, the outlet tube 36112 can be inserted into the connector 3623, so as to allow the slurry material 200 in the pulping container 3611 to be pumped into the pot 313 through the slurry supply duct 36111 and the feeding pipe 3622.

In addition, to remove the pulping container 3611 from the container base 3615, the user simply presses a release button 36114 which is coupled to the outlet tube 3611, so as to disengage the outlet tube 3611 from the connector 3623 and allowing the entire pulping container 3611 to be lifted out as a single unit.

Preferably, the connector 3623 is a self-locking connector, so as to ensure leak-proof and reliable slurry transmission. When the outlet tube 36112 is inserted into the connector 3623, the self-locking state of the connector 3623 is unlocked, and the slurry material 200 in the slurry supply duct 36111 can be guided into the feeding pipe 3622.

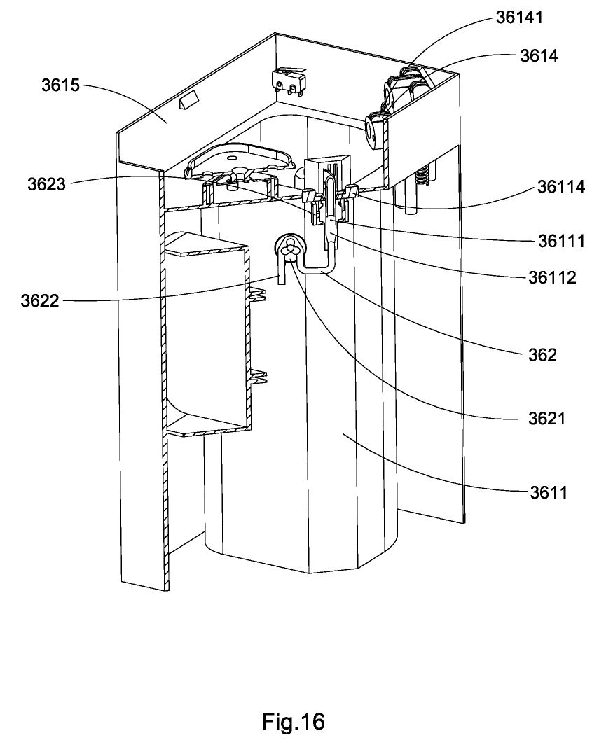

During installation of the pulping container 3611, as shown in FIG. 16, the water feeding unit 3614 comprises a water inlet slider element 36141 which is pushed downward and locked into a groove 36113 in the pulping container 3611 and a water tank 36142 which is connected to the water inlet slider element 36141. In this state, water can flow smoothly into the interior of the pulping container 3611 to support pulping or cleaning functions.

When the pulping container 3611 is removed, a return spring 36143 can be provided to cause the water inlet slider element 36141 to automatically move upward, thereby disengaging from the groove 36113 of the pulping container 3611. In this raised position, the water inlet slider element 36141 no longer obstructs the movement path of the pulping container 3611, allowing the pulping container 3611 to be easily removed without interference.

The slurry supply assembly 360 further comprises a weighting unit 363 which is used to weigh the weight of the raw material of the slurry material 200, so as to determine the amount of the water added into the pulping container 3611 for preparing the slurry material 200.

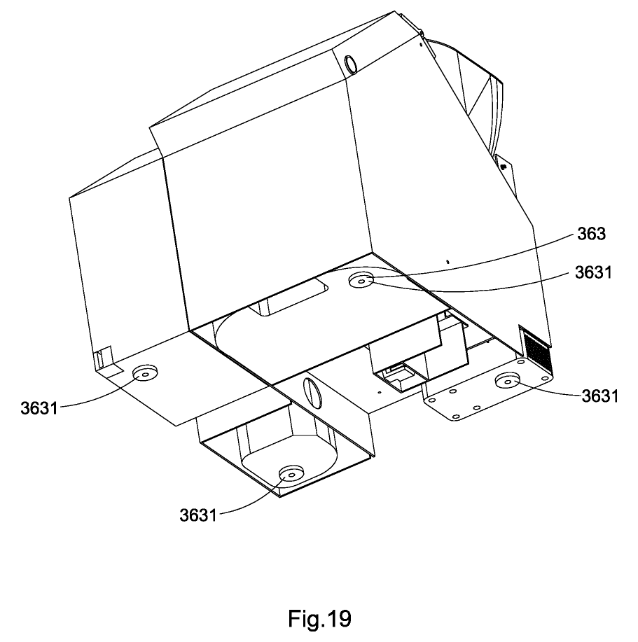

As an example, as shown in FIG. 19, load-bearing feet can be positioned at the bottom of the pet food flavor enhancement processing system 3 and each integrated with a weighing sensor 3631. These load-bearing feet are configured to continuously measure the total weight of the slurry supply assembly 360 and its contents in real time. By distributing the load across multiple sensing points, the system ensures stable support while providing accurate and dynamic weight monitoring during operation.

This structural arrangement allows the weighing unit 363 to function without interfering with the coating, heating, or pulping operations, and enables the system to monitor weight changes throughout the processing cycle. It is particularly useful for tracking the amount of the raw material of the slurry material 200 added, thereby supporting automated dosing, portion control, and process optimization.

In this embodiment, the weighing unit 363 can be implemented to use half-bridge load cells as the weighting sensors 3631, with four load cells arranged in matched pairs. This configuration provides a stable mechanical structure and allows for accurate and balanced weight measurement under varying load conditions. The use of four symmetrically arranged half-bridge sensors enhances system sensitivity and compensates for positional deviations during weighing.

Such a configuration improves the linearity and repeatability of the weighing process and enables high-precision readings even in compact or portable systems. Moreover, the structural stability provided by the four-point sensor arrangement ensures uniform load distribution, reducing measurement error caused by uneven placement of the materials being weighed.

The control assembly 340 further comprises a display screen 343 configured to provide real-time interactive instructions and feedback to the user during the preparation of pet food processed food 1. As an example, when the machine enters a pet food preparation mode, the display screen prompts the user to add meat as a primary ingredient. In response, the user removes the pulping container 3611 and places the selected meat ingredients into the container. The weighting unit 363 automatically measures the weight of the added meat and displays the measured value on the screen.

The user may then select the type of meat via an input interface (e.g., touch panel or button), choosing from options such as poultry, fish, or red meat (e.g., pork, beef, or lamb). Based on the selected meat type, the system adjusts subsequent prompts and calculations.

The display then prompts the user to optionally add vegetables. If vegetables are added, the weight unit 363 again measures the vegetable weight and displays the value. After confirming the total combined weight of meat and vegetables, the machine automatically calculates and displays the corresponding amount of water to be added, ensuring proper slurry consistency.

In this embodiment, the pump 3621 can be a peristaltic pump which is employed to transport the slurry material 200 from the pulping container 3611 to the pot 313. The slurry feeding unit 362 further comprises an air flow duct 3624 and a linkage mechanism 3625. At the nozzle outlet 36221 of the feeding pipe 3622, a stream of high-speed airflow is introduced to atomize and diffuse the slurry material 200 by the air flow duct 3624. This air-assisted atomization ensures that the slurry material 200 is finely dispersed and can achieve uniform and effective adhesion to the surface of the pet food raw material 10.

An inlet 36241 of the the pressurized airflow branch of the air flow duct 3624 is provided between the air blower 351 and the heating element 321, and is configured to divert a portion of unheated air toward the nozzle outlet 36221 through an outlet 36242. This diverted cold airflow is directed to the nozzle outlet 36221 to perform atomization and dispersion of the slurry material 200.

Specifically, prior to entering the heating element 321 for hot air generation, part of the blower output is branched off through the air flow duct 3624 that channels pressurized cold air to the nozzle outlet 36221. This cold, high-velocity airflow interacts with the slurry material 200 delivered from the peristaltic pump at the nozzle outlet 36221, thereby facilitating the atomization of the slurry material 200 into fine droplets and enabling uniform diffusion onto the pet food raw material 10.

The air flow duct 3624 and the feeding pipe 3622 are structurally supported by the linkage mechanism 3625 which controls the position and movement of the nozzle outlet 36221 relative to the pot 313. During operation, the nozzle outlet 36221 is positioned in front of the pot 313, such that the atomized meat slurry is directed entirely into the interior of the pot 313, thereby preventing overspray and spillage outside the coating area.

The housing 330 comprises a door 333 movably arranged at the position corresponding to the pot 313, when the door 333 is opened, the linkage mechanism 3625 is configured to rotate the nozzle outlet 36221 and cause it to retract or fold to the inner surface of the door 333. This movement allows the nozzle outlet 36621 to be stored compactly, avoiding interference with the pot removal path. As a result, the user can smoothly insert or extract the pot 313 without obstruction from the feeding pipe 3622 and the air flow duct 3624.

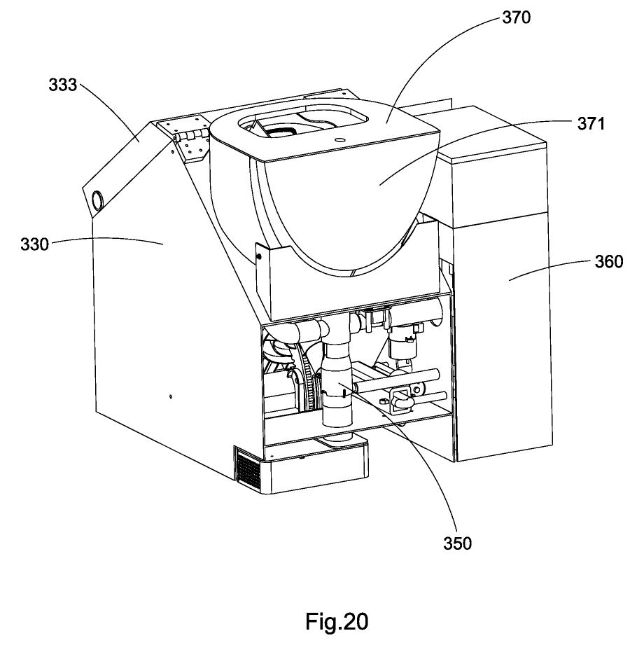

As shown in FIGS. 20 to 22, the pet food flavor enhancement processing system 3 further comprises a pet food feeding mechanism 370 for feeding a plurality of the pet food raw materials 10 into the pot 313 for coating the slurry material 200.

More specifically, the pet food feeding mechanism 370 comprises a pet food storing container 371 for storing the pet food raw materials 10, a support frame 372 supporting the pet food storing container 371 and a pet food feeding unit 373 for feeding the pet food raw materials 10 from the pet food storing container 371 to the pot 313.The pet food storing container 371 is preferred to be detachable from the support frame 372, so as to be easy for clean.

In this embodiment, the pet food feeding unit 373 comprises a feeding driving motor 3731, a transmission shaft 3732 coupled to the feeding driving motor 3731, and a rotation disc 3733 inclinedly arranged in the pet food storing container 371 and coupled to the transmission shaft 3732. The pet food storing container 371 has an pet food outlet 3711 positioned above the pot 313, the rotation disc 3733 has at least one discharge outlet 37331. When the feeding driving motor 3731 is in operation to drive the transmission shaft 3733 to rotate, the rotation disc 3733 is driven to rotate by the transmission shaft 3733, when the discharge outlet 37331 is aligned with the pet food outlet 3711 positioned above the pot 313, the pet food raw materials 10 in the pet food storing container 371 will drop into the pot 313 because of gravity through the discharge outlet 37331 and the pet food outlet 3711.

The transmission shaft 3732 can be further configured with one or more protruding trigger structures and a counter 37321. When there are two discharge outlets 37331 at two opposite sides of the rotation dis 3733, these protrusions are positioned such that for every 180° rotation of the rotation disc 3733, a counting signal is generated. By monitoring the number of the counting signals, the system can quantitatively determine the amount of pet food raw materials added to the pot 313.

The pet food feeding unit 373 further comprises an infrared transmitting source 3734, an infrared receiver 3735, and an infrared-permeable area 3736 on the pet food storing container 371. The infrared transmitting source 3734 and the infrared receiver 3735 are arranged on two opposite sides of the infrared-permeable area 3736. When the pet food raw materials accumulates to a predetermined height, the infrared beam is interrupted, preventing the infrared receiver 3735 from detecting the signal. When the pet food raw material level falls below the beam path, the signal reaches the infrared receiver 3735, triggering a refill prompt or automatic feeding response. Accordingly, when the amount of the pet food raw materials in the pet food storing container 371 is insufficient, the infrared signal emitted by the infrared transmitting source 3734 passes through the infrared-permeable area 3736 and reaches the infrared receiver 3735, such that the infrared receiver 3735 detects a valid signal input. This condition is interpreted by the system as an indication that the pet food raw material level has fallen below the preset threshold.

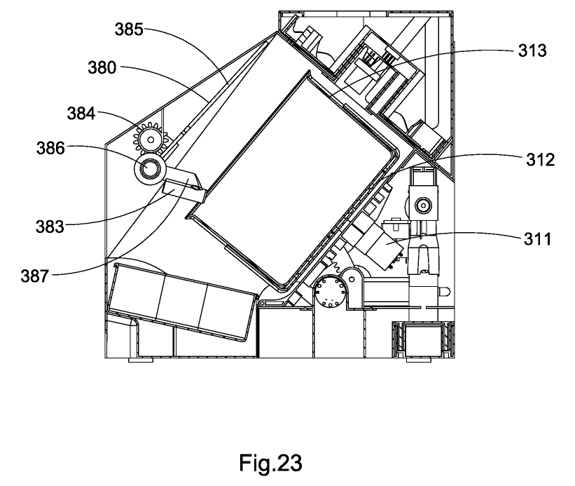

As shown in FIGS. 23 to 25, the pet food flavor enhancement processing system 3 further comprises a cleaning assembly 380 which comprises a water heater 381 connected to the water tank 36142, a water pump 382 connected to the water heater 381, and a water feeding pipe 383 connected to the water pump 382 for feeding heated water into the pot 313.

The cleaning assembly 380 further comprises a drain motor 384, a wastewater suction pipe 385 and a wastewater peristaltic pump 386. After cleaning the components in the pot 313, the drain motor 384 is configured to drive the wastewater suction pipe 385 to rotate downward, such that its lower end extends into the bottom of the pot 313. The wastewater peristaltic pump 386 is then activated to extract the wastewater from the pot 313 and discharge it externally. The cleaning assembly 380 may further comprise a cleaning air flow duct 387 which is connected to the air blower assembly 350 for directing air into the pot 313.

It should be understood by those skilled in the art that the embodiments of the present invention described above and shown in the accompanying drawings are only examples and do not limit the present invention. The purpose of the present invention has been fully and effectively achieved. The functional and structural principles of the present invention have been demonstrated and explained in the embodiments, and the embodiments of the present invention may be deformed or modified in any way without departing from the principles.

What is claimed is:

1. A pet food flavor enhancement processing system, comprising an automatic slurry coating assembly for coating a slurry material on a surface of a pet food raw material to form a flavor enhancement layer on the surface of the pet food raw material.

2. The pet food flavor enhancement processing system according to claim 1, wherein said automatic slurry coating assembly is configured to coat the slurry material on the surface of the pet food raw material by one of spraying, soaking, brushing, vibration and liquid stirring.

3. The pet food flavor enhancement processing system according to claim 1, wherein said automatic slurry coating assembly comprises a rotation motor and a pot for receiving the slurry material and the pet food raw material, wherein said pot is driven by said rotation motor to allow the slurry material to be coated on the surface of the pet food raw material.

4. The pet food flavor enhancement processing system according to claim 3, wherein said automatic slurry coating assembly further comprises a rotation pot base coupled to said rotation motor, wherein said pot is detachably coupled on said rotation pot base.

5. The pet food flavor enhancement processing system according to claim 4, wherein said rotation pot base comprises a rotation container having a receiving chamber and an opening communicated to said receiving chamber, said pot is detachably disposed into said receiving chamber of said rotation pot base through said opening.

6. The pet food flavor enhancement processing system according to claim 5, wherein said pot comprises a bottom wall and a surrounding wall connected to said bottom wall to define an inner chamber having an access opening, wherein said rotation container comprises a bottom surface and a surrounding surface connected to said bottom surface to define said receiving chamber, wherein said surrounding surface of said rotation container is matched with and in frictional contact with said surrounding wall of said pot, so as to allow said rotation container to drive said pot to rotate, wherein said rotation motor is mounted at a bottom of said rotation container.

7. The pet food flavor enhancement processing system according to claim 3, further comprising a heating assembly to dry the slurry material to promote solidification of the slurry material for forming the flavor enhancement layer on the pet food raw material.

8. The pet food flavor enhancement processing system according to claim 7, wherein said heating assembly comprises a heating element for heating said pot.

9. The pet food flavor enhancement processing system according to claim 7, further comprising an air blower assembly which comprises a blower housing and an air blower disposed in said blower housing for generating an air flow, wherein said heating assembly comprises a heating element which is disposed in said blower housing for heating the air flow from the air blower, and a heat air duct for guiding heated air to the pot.

10. The pet food flavor enhancement processing system according to claim 9, further comprising a housing having a cavity for receiving said pot, wherein said housing has air outlet formed in said housing and is communicated to said cavity and said heat air duct, wherein said air outlet is above said pot and is oriented to direct heated air into said pot.

11. The pet food flavor enhancement processing system according to claim 7, further comprising a slurry supply assembly which comprises a pulping unit for preparing the slurry material based on a raw material which is added with water, and a slurry feeding unit for feeding the slurry material to said pot.

12. The pet food flavor enhancement processing system according to claim 11, wherein said pulping unit comprises a pulping container for receiving the raw material of the slurry material, a mincing element for mincing the raw material of the slurry material, a pulping driving mechanism for driving movement of said mincing element, a water feeding unit for feeding water into said pulping container.

13. The pet food flavor enhancement processing system according to claim 12, wherein said pulping driving mechanism comprises a shell, a driving motor, and a crank-slider linkage mechanism mounted to the shell, wherein said mincing element is detachably mounted to said shell, said driving motor is configured to drive said mincing element to perform a reciprocating up-and-down motion via said crank-slider linkage mechanism.

14. The pet food flavor enhancement processing system according to claim 12, wherein said pulping unit comprises further comprises a container base for receiving said pulping container, wherein said pulping container is provided with a slurry supply duct which comprises an outlet tube, said slurry feeding unit comprises a pump, a feeding pipe and a connector, wherein said feeding pipe is connected to said pump and said connector, said connector is connected to said outlet tube when said pulping container is detachably mounted on said container base.

15. The pet food flavor enhancement processing system according to claim 14, wherein said water feeding unit comprises a water tank and a water inlet slider element which is connected to said water tank, wherein said pulping container has a groove, said water inlet slider element is pushed downward and locked into said groove of said pulping container when said pulping container is detachably mounted on said container base, wherein said water feeding unit further comprises a return spring to cause said water inlet slider element to automatically move upward for disengaging from said groove of said pulping container when said pulping container is removed from said container base.

16. The pet food flavor enhancement processing system according to claim 12, wherein said slurry supply assembly further comprises a weighting unit which is used to weigh a weight of the raw material of the slurry material added into said pulping container, so as to determine an amount of the water added into said pulping container for preparing the slurry material.

17. The pet food flavor enhancement processing system according to claim 12, wherein said slurry feeding unit comprises comprises a pump, a feeding pipe connected to said pump and communicated to said pulping container for feeding said slurry material to said pot, and an air flow duct, wherein said feeding pipe comprises a nozzle outlet, wherein a stream of pressurized airflow is introduced to said nozzle outlet to atomize and diffuse the slurry material by said air flow duct.

18. The pet food flavor enhancement processing system according to claim 3, further comprising a pet food feeding mechanism for automatically feeding a plurality of the pet food raw materials into said pot, wherein said pet food feeding mechanism comprises a pet food storing container for storing the plurality of pet food raw materials, and a pet food feeding unit for feeding the plurality of pet food raw materials from said pet food storing container to said pot.

19. The pet food flavor enhancement processing system according to claim 18, wherein said pet food feeding unit comprises a feeding driving motor, a transmission shaft coupled to said feeding driving motor, and a rotation disc inclinedly arranged in said pet food storing container and coupled to said transmission shaft, wherein said pet food storing container has an pet food outlet positioned above said pot, said rotation disc has at least one discharge outlet , wherein when said feeding driving motor is in operation to drive said transmission shaft to rotate, said rotation disc is driven to rotate by said transmission shaft, when said discharge outlet is aligned with said pet food outlet, the pet food raw materials in the pet food storing container drops into said pot because of gravity through said discharge outlet and said pet food outlet.

20. The pet food flavor enhancement processing system according to claim 19, wherein said pet food feeding unit further comprises an infrared transmitting source, an infrared receiver, and an infrared-permeable area on said pet food storing container, wherein said infrared transmitting source and said infrared receiver are arranged on two opposite sides of said infrared-permeable area, wherein when an amount of the pet food raw materials in said pet food storing container is insufficient, an infrared signal emitted by said infrared transmitting source passes through said infrared-permeable area and reaches said infrared receiver.

21. The pet food flavor enhancement processing system according to claim 15, further comprising a cleaning assembly which comprises a water heater connected to said water tank, a water pump connected to said water heater, and a water feeding pipe connected to said water pump for feeding heated water into said pot.

22. The pet food flavor enhancement processing system according to claim 21, wherein said cleaning assembly further comprises a drain motor, a wastewater suction pipe and a wastewater peristaltic pump, wherein said the drain motor is configured to drive said wastewater suction pipe to rotate downward to allow a lower end thereof to extend into said pot, said wastewater peristaltic pump extracts wastewater from said pot through said wastewater suction pipe.

23. The pet food flavor enhancement processing system according to claim 3, wherein the pet food raw material is a commercial sold product.

24. The pet food flavor enhancement processing system according to claim 11, wherein the raw material of the slurry material is selected from the group consisting of meat, vegetable, fruit and dairy product.
